(19) United States
(12) Patent Application Publication
(10) Pub. No.: US 2011/0036461 A1
(43) Pub. Date: Feb. 17, 2011

(54) Method and Equipment for Flame Cutting a Steel Part

(75) Inventors: Michel Saez, Lamorlaye (FR); Sebastien Bully, Maisons Laffitte (FR)

Correspondence Address: American Air Liquide, Inc.;Intellectual Property Dept., 2700 Post Oak Boulevard, Suite 1800, Houston, TX, 77056, US

(73) Assignee: L'Air Liquide Societe Anonyme Pour L'Etude Et L'Exploitation Des Procedes Georges Claude, Paris (FR)

(21) Appl. No.: 12/989,153

(22) PCT Filed: Apr. 16, 2009
(86) PCT No.: PCT/FR2009/050706

§ 371 Date: Oct. 22, 2010

(30) Foreign Application Priority Data
Apr. 24, 2008 (FR) 0852747

(51) Int. Cl. B23K 7/00; B23K 7/06

(52) U.S. Cl. 148/194; 266/48

(57) ABSTRACT

The invention relates to a method for flame cutting a part made of a metal containing iron, implementing at least one blowtorch having a cutting nozzle, wherein the operation is carried out according to the steps of preheating a localized area of the part by means of a flame obtained by the combustion of a combustible gas and oxygen, then directing the gaseous oxygen towards the preheated localized area into a first pressure and/or first flow for initiating a bore while shifting the blowtorch in the cutting direction. Then, after initiating a bore in the part, the pressure and/or flow of gaseous oxygen is increased in the direction of the bore start area to a second pressure higher than the first pressure and/or a second flow higher than the first flow to obtain the complete bore in the part. The invention also relates to associated equipment.

The present invention relates to an oxy-fuel cutting process that avoids or minimizes the spatter of molten metal between the preheating and the piercing of a metal plate, which process is particularly suitable for installations that lack a device for varying the feed pressure of the cutting oxygen.

Oxy-fuel cutting is a cutting process widely used for cutting steel or, more generally, ferrous materials, that is to say materials containing iron.

From the industrial standpoint, this process is implemented using installations or machines comprising, in the simplest installations, 1 or 2 torches, and, in the most complex installations, up to 6 to 12 torches operating in parallel. Typically, an oxy-fuel cutting machine comprises from 1 to 8 torches.

In fact, oxy-fuel cutting is a cutting process that cuts by continuous localized combustion of the metal with a pure oxygen jet. This process is a well known in the industry. The process is first initiated, during a phase called the initiation or preheating phase, with a high-temperature oxy-fuel flame which brings, locally, the workpiece to be cut to its ignition temperature, that is to say to about 1150° C., and then the combustion reaction is started and sustained, during the piercing phase followed by the actual cutting, by supplying an oxygen jet, right along the desired cutting path.

Materials that can be oxycut are mainly those that contain iron, particularly low-alloy or unalloyed steels, especially carbon steels.

The main factors affecting cutting performance are the cutting equipment, in particular the choice of cutting nozzle, the purity of the gases (fuel and oxygen), the material to be cut and the skill of the operator.

Oxy-fuel cutting is mainly used for cutting steel workpieces of thicknesses greater than 10 mm because at lesser thicknesses the process reaches its limits, namely a cutting quality and performance that are unacceptable from the industrial standpoint.

For thicknesses greater than 30 mm, when piercing the plate, that is the workpiece to be cut, away from its edges and just after the preheating of the workpiece, it has been noticed that certain recurrent problems also exist, such as molten metal splashback onto the nozzle and inadvertent flashback which cause degradation of the cutting equipment, cutting defects due to dirty nozzles, non-perpendicular cut face defects and difficulties in starting the cut.

In fact, most of these problems are caused by or result from adhering molten metal spatter produced just after the preheating of the plate, that is to say during the piercing thereof.

This phenomenon is accentuated when a nozzle is used at high pressure, typically higher than 8 bar, and with a high oxygen flow rate, that is to say at least 3900 l/h, because of the immediate reaction that occurs with the arrival of a large quantity of oxygen.

This phenomenon is, moreover, amplified when several oxy-fuel cutting torches operate in parallel as well as when high-pressure nozzles, which have instantaneous cutting oxygen flow rates of 7 to 12 bar, are used.

The aim of the invention is therefore to provide an improved oxy-fuel cutting process that avoids or minimizes all or some of the aforementioned problems by minimizing or avoiding the spatter of molten metal during the piercing of the plate, at the start of cutting.

The solution of the invention is a process, employing at least one torch equipped with a cutting nozzle, for oxy-fuel cutting an iron containing metal workpiece, which proceeds according to the steps of:

a) preheating a localized region of the workpiece by means of a flame obtained by combustion of a combustible gas and oxygen; and

b) supplying, in the direction of the localized region preheated in step a), gaseous oxygen at a first pressure and/or a first flow rate in order to initiate piercing, whilst at the same time moving the torch in the cutting direction,

This process is characterized in that it furthermore comprises the following step c):

c) after the piercing of the workpiece has been initiated in step b), the pressure and/or the flow rate of the gaseous oxygen supplied in the direction of the region where the piercing started is increased up to a second pressure and/or a second flow rate that are higher than the first pressure and/or first flow rate in order to perforate the workpiece.

As required, the process of the invention may comprise one or more of the following features:
the combustible gas of step a) and the oxygen of steps a), b) and c) are supplied through the nozzle (1) which is located facing the upper surface of the workpiece;
in step a) the workpiece is preheated until at least the ignition temperature of the metal of the workpiece is reached in said localized region of the workpiece, preferably a temperature greater than or equal to 1150° C.;
in step b) the nozzle is furthermore moved away from the upper surface of the workpiece in order to position said nozzle at a piercing distance (d) of between 1 cm and 5 cm, typically about 2 cm to 3 cm, from the upper surface of the workpiece;
after the nozzle has been moved away from the upper surface of the workpiece, but before the perforation of the workpiece, the nozzle is moved relative to the workpiece so as at least to initiate a kerf;
in step c) the nozzle is moved toward the upper surface of the workpiece to a cutting distance (d′) of between 0.5 cm and 1.5 cm, with d′<d, and concomitantly the pressure and/or flow rate of the gaseous oxygen, supplied in the direction of the pierced region, is increased;
the first oxygen pressure is lower than about 2 bar and the second oxygen pressure is higher than 2 bar, preferably higher than 5 bar;
the thickness of the workpiece is greater than 25 mm, and is preferably between 30 mm and 100 mm;
the workpiece is made of steel;
the combustible gas used in step a) contains acetylene, ethylene, natural gas or LPG (liquefied petroleum gas); and
it employs several cutting nozzles arranged on several torches that operate simultaneously in order to produce concomitantly several cuts within said workpiece.

Moreover, the invention also relates to an installation for oxy-fuel cutting a workpiece designed to implement the process described above, comprising at least one torch equipped with a cutting nozzle; at least one source of combustible gas and at least one source of oxygen that feed the torch with said combustible gas and said oxygen; means, including a gas circuit, for supplying the cutting nozzle with gaseous oxygen; and means for moving the torch along the cutting path of the workpiece, such as a motorized system conventionally used to produce torch movements on welding/cutting installations, characterized in that the gas circuit comprises a main gas line and a bypass line, said main gas line being provided with a device for controlling the pressure/flow rate of the gas in said main channel so that the flow or the pressure of the gas flowing in the main channel may be completely stopped or limited during step a) of preheating a localized region of the workpiece, and, conversely, so as to allow gas to flow with a certain flow rate and a certain pressure in the direction of the localized region during step b), thus obtaining a gas supplied at a higher pressure and/or a higher flow rate.

Preferably, the device for controlling the pressure/flow rate of the gas is a valve or a pressure and/or flow rate regulator or any other similar device.

Advantageously, the installation comprises several cutting nozzles arranged on several torches, in particular, up to 12 torches, or even more, particularly nozzles mounted on a moving beam, a support frame or the like.

The invention will now be better understood thanks to the following detailed description of the piercing principle and the operating mode, given with reference to the appended figures.

FIGS. 1 to 4 show the principle of an oxy-fuel cutting process according to the invention applied to a 30 mm thick steel plate.

The oxy-fuel cutting process of the invention starts with a conventional step of localized preheating (at 6) of the plate 5 to be cut, as shown in FIG. 1, by supply of a gas mixture formed from oxygen and a combustible gas, to the nozzle (or nozzles) 1 of an oxy-fuel cutting torch 2, to establish a heating flame 3 the objective of which is to preheat the plate 5 to be cut so that it reaches, locally (at 6), its ignition temperature of about 1150° C., so as to maintain a uniform cutting oxygen jet, which is subsequently delivered.

This is because, to perform an oxy-fuel cutting operation, it is necessary to employ in succession at least one “heating” flame and one central “cutting oxygen” jet.

The heating flame must be capable of bringing, very rapidly and locally, the surface of the plate to the ignition temperature of the material, namely, in the case of steel, usually about 1150° C.

When the ignition temperature is reached, the cutting oxygen is unleashed and the combustion reaction of the iron contained in the steel begins. It is therefore of paramount importance to choose the most suitable combustible gas so as to reach the ignition temperature rapidly.

In fact, temperatures of greater than 1500° C. can be obtained with several combustible gas mixtures oxygen. These mixtures are given in the following table.

TABLE

| Gaz mixture | Temperature reached (in ° C.) |
|---|---|
| O₂ + acetylene | 3150 |
| O₂ + ethylene | 2924 |
| O₂ + hydrogen | 2856 |
| O₂ + propane | 2830 |

The heating flame is composed of an inner flame cone and an envelope. In oxy-fuel cutting, only the properties of the inner flame cone are of interest. The inner cone is the area where the mixture of oxidizing gas and combustible gas, introduced into the torch, combust. Very high temperatures may be obtained with this combustion. The amount of energy that it is possible to transmit to the plate depends on the power of the inner cone. Also, this power must be focused onto a small area in order to obtain rapid heating at the place where the cutting operation starts. This amount of energy is defined by the specific power (power per unit area given in kJ/cm².s).

Acetylene is the gas with the highest specific power: 8 kJ/cm².s for a mixture with a 1:1 volume ratio. This power can reach 16 kJ/cm².s with a ratio of 1 m³ of combustible gas to 2 m³ of oxygen.

Acetylene also has the fastest flame propagation rate in oxygen. This is important because it determines the flashback sensitivity and it is one of the factors preventing oxy-fuel cutting machines from being used more widely.

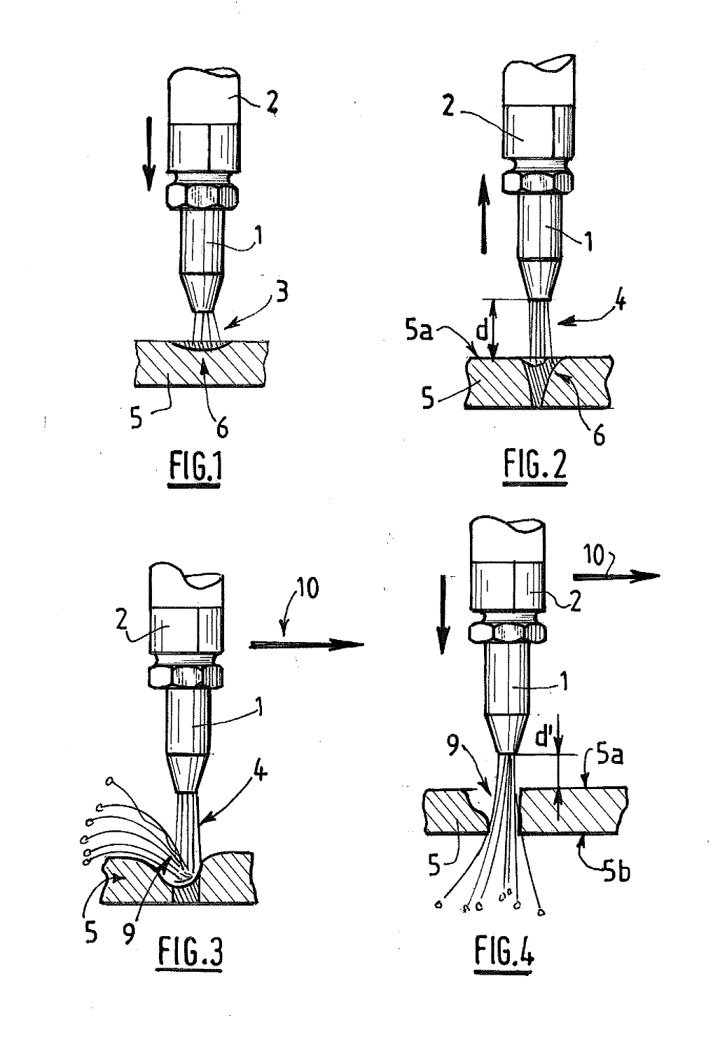

Once the initiation temperature has been reached, for example after a given preset heating time, a cutting oxygen jet 4 is supplied to the preheated region 6, as shown in FIG. 2, whilst, at the same time, the cutting nozzle 1 is slightly retracted, that is to say moved away from the upper surface 5a of the workpiece 5 to be cut, preferably moved away by a distance “d” of about 2 cm to 3 cm approximately.

To avoid the molten metal spatter, it is recommended to control the pressure (and/or the flow rate) of the oxygen cutting jet 4, for example by limiting the pressure to a maximum value of around 0.2 bar to 1 bar and then by beginning to slowly move the torch 2 relative to the workpiece 5 to be cut along the desired cutting path, that is to say in the direction of the arrow 10 of FIG. 3, so as to expel the molten metal toward the rear part 9 of the forming kerf.

According to the invention, the movement of the torch 2 begins before the plate 5 is perforated.

After the torch has been moved, the pressure and/or the flow rate of the cutting oxygen jet 4 supplied to the forming kerf 9 is gradually increased whilst once more the torch 2 is moved toward the upper surface 5a of the plate 5 and whilst the torch 2 continues to move (in the direction 10) along the desired cutting path.

In other words, according to the invention the piercing and cutting of the plate 5 is started, after the localized preheating 6 of the plate 5, by an oxygen jet 4 at a pressure and/or flow rate which are/is less than those employed during the actual cutting.

Next, the oxy-fuel cutting proceeds as usual, to wit via an exothermic combustion process that consists in burning the iron in the steel plate 5 by forming iron oxides with pressurized oxygen. The iron oxides form a molten slag expelled from the oxy-fuel cutting kerf 9 by the pressure of the cutting oxygen jet 4, that is to say expelled below the plate 5.

During the preheating phase (FIG. 1), the combustion reaction is initiated which a gas mixture comprising oxygen as the oxidizer and a combustible gas, such as acetylene, which is “lit” to obtain a combustion flame that brings the metal to its ignition temperature and subsequently triggers the actual combustion of the iron (FIGS. 2 to 4) that it contains. The metal combustion reaction is sustained, during the cutting of the workpiece, only by the supply of pressurized oxygen.

The oxy-fuel cutting according to the invention may be carried out by hand or by a machine, in particular by a machine equipped with several torches 2 that operate in parallel in order to cut identical workpieces (mass-production) within a steel plate or the like.

The process according to the invention is particularly suitable for cutting a plate having a thickness of between 25 mm to 30 mm and 140 mm, typically about 30 mm to 100 mm approximately.

The process of the invention may be implemented with a simple oxy-fuel cutting nozzle or with an oxygen dual flow nozzle. These two type of nozzle are standard.

Thus, a simple nozzle is typically formed from an elongate body having a central axial oxygen duct designed to supply a central oxygen jet, and one or more peripheral gas ducts designed to deliver, during the preheating phase, which is sometimes called the initiation phase, one or more peripheral jets of combustible gas which mix with the oxygen and burn to give the combustion flame, called the heating flame, used for locally preheating the plate.

An oxygen dual flan nozzle is similar to a simple nozzle but furthermore comprises additional internal gas ducts, in fluid communication with the central oxygen duct, designed to divert part of the central oxygen stream, distributing it around the central cutting oxygen jet in order to create a curtain or sheet of oxygen around the central oxygen jet during cutting.

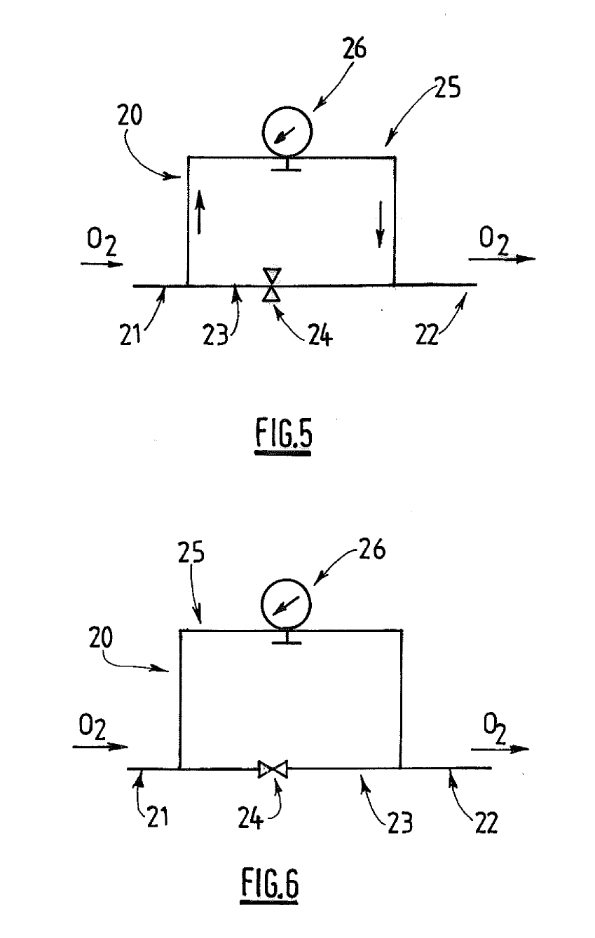

The invention may be implemented by means of a gas circuit 20, such as that shown in FIGS. 5 and 6, which is connected to each of the torches 2 equipped with a nozzle 1.

FIG. 5 shows the circuit 20 in the “closed” position, that is to say in the configuration that must be adopted during preheating and at the start of the cut up to the actual piercing of the workpiece 5, as shown in FIGS. 1 to 3, whereas FIG. 6 shows the circuit 20 in the “open” position, that is to say in the configuration that must be adopted after the piercing and during the cutting, as shown in FIG. 4.

As may be seen, the gas circuit 20 comprises a main gas channel 23 with an inlet 21 for pressurized oxygen (O₂), for example at 10 bar, and an oxygen outlet 22, fluidically connected to the torch(es).

The main channel 23 furthermore comprises a valve, for example a ¼ turn valve, which controls whether gas flows in the main channel, in particular during cutting (cf. FIG. 4).

Moreover, the circuit 20 includes a bypass line 25, for bypassing the valve 24, equipped with a gas pressure regulator 26 for controlling the pressure (or flow rate) flowing in this bypass line 25, for example a regulator 26 with an operating range of 0 to 2 bar.

When the circuit 20 is in the “closed” position, as illustrated in FIG. 5, the high-pressure (10 bar) oxygen arriving via the inlet 21 passes through the bypass line 25 and not through the main line 23 since the valve 24 is closed. The gas is then expanded in the regulator 26 down to the desired low pressure, for example 0.5 bar, for implementing the steps illustrated in FIGS. 1 to 3, before flowing toward the outlet 22 in the direction of the torch.

Once piercing is obtained, the valve 24 is opened and the circuit 20 is again in the configuration, FIG. 6, used for the actual cutting, as illustrated in FIG. 4. The gas then essentially flows along the main line 23 through the valve without expansion therein. The gas is therefore supplied at high pressure (10 bar) to the torch.

The valve 24 may be a solenoid valve automatically controlled, even remotely, by a digital CNC panel or any control cabinet or suitable computer.

Similarly, the pressure level of the regulator 26 may also be controlled automatically by a CNC or the like.

In fact, it is essentially the switching of the valve 24 in this exemplary embodiment that varies the oxygen pressure, thereby passing from one step of the process according to the invention to another.

Naturally, the valve 24 is switched synchronously or in coordination with the movements of the torch nozzle away from or toward the upper surface of the plate to be cut, as well as with the relative displacement movement between the torch and said plate to be cut, as explained above.

The circuit 20 and its various components may be attached by means of a support and fastening plate, or any other similar system, to the oxy-fuel cutting machine.

When several torches are used in parallel, each torch may be fed by its own dedicated circuit 20 of gas feed lines, or else the same circuit 20 may feed several torches with gas.

1-10. (canceled)

11. A process, employing at least one torch equipped with a cutting nozzle, for oxy-fuel cutting an iron-containing metal workpiece, which proceeds according to the steps of:
a) preheating a localized region of the workpiece by means of a flame obtained by combustion of a combustible gas and oxygen; and
b) supplying, in the direction of the localized region preheated in step a), gaseous oxygen at a first pressure and/or a first flow rate in order to initiate piercing, whilst at the same time moving the torch in the cutting direction,
c) after the piercing of the workpiece has been initiated in step b), the pressure and/or the flow rate of the gaseous oxygen supplied in the direction of the region where the piercing started is increased up to a second pressure and/or a second flow rate that one higher than the first pressure and/or first flow rate in order to perforate the workpiece.

12. The process of claim 11, wherein the combustible gas of step a) and the oxygen of steps a), b) and c) are supplied through the nozzle which is located facing the upper surface of the workpiece.

13. The process of claim 11, wherein step a) the workpiece is preheated until at least the ignition temperature of the metal of the workpiece is reached in said localized region of the workpiece.

14. The process of claim 11, wherein step b) the nozzle is furthermore moved away from the upper surface of the workpiece in order to position said nozzle at a piercing distance of between 1 cm and 5 cm from the upper surface of the workpiece.

15. The process of claim 11, wherein after the nozzle has been moved away from the upper surface of the workpiece, but before the perforation of the workpiece, the nozzle is moved relative to the workpiece so as at least to initiate a kerf.

16. The process of claim 11, wherein step c) the nozzle is moved toward the upper surface of the workpiece to a cutting distance of between 0.5 cm and 1.5 cm, and concomitantly the pressure and/or flow rate of the gaseous oxygen, supplied in the direction of the pierced region, is increased.

17. The process of claim 11, wherein the first oxygen pressure is lower than about 2 bar and the second oxygen pressure is higher than 2 bar, preferably higher than 5 bar.

18. The process of claim 11, wherein it employs several cutting nozzles arranged on several torches that operate simultaneously in order to produce concomitantly several cuts within said workpiece.

19. An apparatus for oxy-fuel cutting a workpiece, comprising:
at least one torch equipped with a cutting nozzle;
at least one source of combustible gas and at least one source of oxygen configured to feed the torch with said combustible gas and said oxygen;
a gas circuit configured to supply the cutting nozzle with gaseous oxygen; and
characterized in that the gas circuit comprises a main gas line and a bypass line, said main gas line being provided with a pressure/flow rate control device for controlling the pressure/flow rate of the gas in said main channel,
and wherein the apparatus is adapted to move the torch along the cutting path of the workpiece.

20. The apparatus of claim 19 comprising more than one torch with a cutting nozzle.
